(19) United States
(12) Patent Application Publication
(10) Pub. No.: US 2006/0099453 A1
(43) Pub. Date: May 11, 2006

(54) Substrate structure connectable by means of magnetic attraction

(76) Inventor: Hung-Chih Wu, Taipei (TW)

Correspondence Address: BRUCE H. TROXELL;SUITE 1404, 5205 LEESBURG PIKE, FALLS CHURCH, VA, 22041, US

(21) Appl. No.: 10/984,741

(22) Filed: Nov. 10, 2004

(51) Int. Cl. B32B 15/00

(52) U.S. Cl. 428/692.1

(57) ABSTRACT

A substrate structure connectable by means of magnetic attraction, including a substrate and a magnetic material layer or a magnetically attractable material layer painted on at least a part of a surface of the substrate. By means of the magnetic material layer or the magnetically attractable material layer, the substrate can be easily magnetically attached to a face of an article with magnetic attraction.

### BACKGROUND OF THE INVENTION

The present invention is related to a substrate structure connectable by means of magnetic attraction which can be easily detachably attached to a face of an article with magnetic attraction.

The existent board materials can be substantially divided into two types according to the application thereof. One type is used to partition the space. The other type is used to protect an exhibited article. The board materials include transparent and opaque (or semitransparent) products. The connection or assembling measure of these board materials is varied with the properties thereof. For example, with respect to an opaque board material, after assembled, the back face is often shaded and invisible. Therefore, the auxiliary members of the assembly, such as a frame or fixing parts, are not limited to a specific pattern and color. Therefore, the auxiliary members can be freely applied to the assembly. Reversely, with respect to the opaque or semitransparent board material, in the case that the auxiliary members are not properly shaded after assembled, the auxiliary members will be exposed to outer side. This will lead to poor appearance of the assembly. Therefore, the auxiliary members must be specially designed in pattern and color so as to avoid ruin of the entire appearance. Moreover, it is troublesome and laborious to fix the board material with these fixing parts. Therefore, it is necessary to provide a simple measure for conveniently and quickly assembling the board materials.

### SUMMARY OF THE INVENTION

It is therefore a primary object of the present invention to provide a substrate structure which can be easily and quickly connected with an article. The substrate structure includes a substrate and a magnetic material layer or a magnetically attractable material layer painted on at least a part of a surface of the substrate. Accordingly, a very thin magnetic structure is applied to the substrate without affecting the appearance thereof. By means of the magnetic material layer or the magnetically attractable material layer, the substrate can be easily magnetically attached to a face of an article with magnetic attraction. Therefore, the substrate can be easily and quickly connected with the article without using any fixing member:

It is a further object of the present invention to provide the above substrate structure which is attached to the article face-to-face. Therefore, the problem of concentration of stress can be solved and the possibility of damage of the substrate caused by the concentrated stress can be minimized.

The present invention can be best understood through the following description and accompanying drawings wherein:

### BRIEF DESCRIPTION OF THE DRAWINGS

FIG. 1-1 is a perspective exploded view showing the assembly of a conventional substrate and a frame body;

FIG. 1-2 is a perspective assembled view according to FIG. 1-1;

FIG. 2 is a sectional assembled view according to FIG. 1-2;

FIG. 3-1 is a perspective exploded view of a preferred embodiment of the present invention;

FIG. 3-2 is a perspective assembled view according to FIG. 3-1;

FIG. 4 is a sectional assembled view according to FIG. 3-2; and

FIG. 5 is a perspective exploded view showing that the substrate of the present invention is fully painted with the magnetic material layer.

### DETAILED DESCRIPTION OF THE PREFERRED EMBODIMENTS

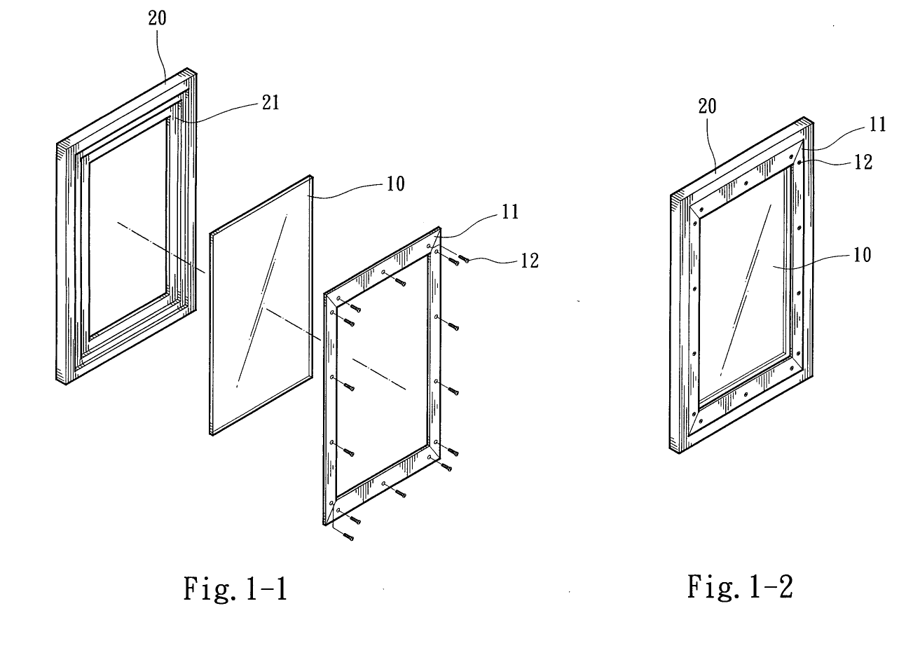

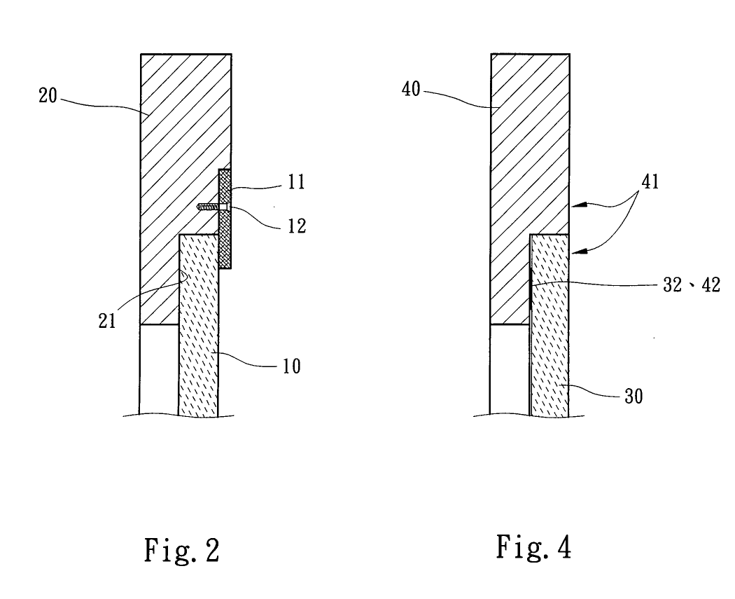

Please refer to FIGS. 1-1 to 2. Conventionally, a substrate 10 can be assembled with an article 20 such as a frame body. The article 20 is formed with a receiving frame 21 in which the substrate 10 is inlaid. The substrate 10 is overlaid with a pressboard 11. Then, the pressboard 11 is fixed by fixing members 12 such as nails to fix the substrate 10 in the receiving frame 21. Such fixing procedure is troublesome and the cost for the materials or parts is increased.

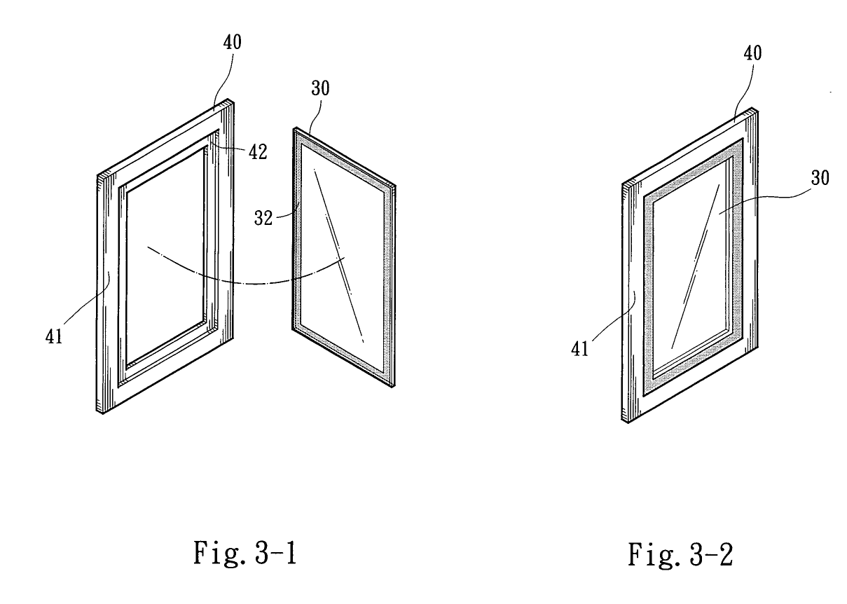

Please refer to FIGS. 3-1 to 4. The present invention includes a substrate 30 and a magnetic material layer 32 disposed on at least a part of the surface of the substrate 30. That is, the magnetic material layer 32 is at least partially painted on the surface of the substrate 30 (such as along the periphery of the substrate 30 or over the entire surface of the substrate 30) by a painting device. The magnetic material can be barium, strontium, rubidium, cobalt or boron or compounds thereof. The magnetic material layer 32 is magnetized to have magnetic attraction. The article 40 has an attaching face 41 corresponding to the magnetic material layer 32. A magnetically attractable coating or element 42 (such as ferrous material or element) is painted or disposed on the attaching face 41. When assembled, the magnetic material layer 32 of the substrate 10 is attached to the magnetically attractable coating or element 42 and magnetically attracted by the magnetic element 42. Therefore, the substrate 10 can be easily and conveniently connected with the article 40 without using any fixing member. When it is necessary to detach or replace the substrate 30, the substrate 30 is simply removed from the surface of the article 40 (or frame body) without unfastening the fixing members.

Besides, the hard substrate 30 (such as hardened or semi-hardened plastic board, glass, hardened resin board, stone material, wooden board, ceramic/porcelain board, metal board, etc.) often has a polished surface and properties incompatible with the magnetic material. Therefore, it is hard to firmly adhere the magnetic material to the substrate 30. To solve this problem, prior to painting of the magnetic material layer 32, the surface on which the magnetic material layer 32 is to be painted is previously treated by corona or flame or is previously ground or is previously painted with a surface property changing agent, a surface optical manufacturing agent or an adhesive. Alternatively, a film made of interface material is previously laid or attached between the surface of the substrate and the magnetic material layer 32 to enhance the bonding strength between the magnetic material layer 32 and the substrate 30. This minimizes the possibility of detachment caused after a long period of use.

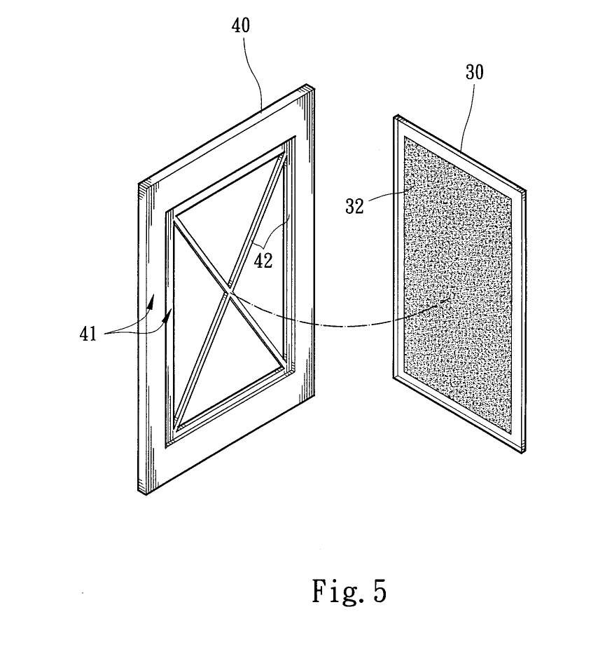

FIG. 5 shows that the magnetic material layer 32 can be painted on the entire surface of the substrate 30 for more conveniently attaching to an article with irregular configuration.

Alternatively, the substrate 30 can be painted with a magnetically attractable material, while the attaching face 41 of the article 40 can be painted with a magnetic material layer or provided with a magnetic element.

The above embodiments are only used to illustrate the present invention, not intended to limit the scope thereof. Many modifications of the above embodiments can be made without departing from the spirit of the present invention.

What is claimed is:

1. A substrate structure connectable by means of magnetic attraction, comprising a substrate and a magnetic material layer painted on at least a part of at least one face of the substrate, the magnetic material layer being magnetized to have magnetic attraction, whereby by means of the magnetic material layer, the substrate can be magnetically attached to a corresponding face of an article with magnetic attraction.

2. The substrate structure as claimed in claim 1, wherein the magnetic material layer is painted on one face of the substrate along a periphery thereof.

3. The substrate structure as claimed in claim 1, wherein the magnetic material layer is entirely painted over at least one face of the substrate.

4. The substrate structure as claimed in claim 1, wherein the face of the substrate on which the magnetic material layer is to be painted is previously treated with corona and then the magnetic material layer is painted on the face.

5. The substrate structure as claimed in claim 2, wherein the face of the substrate on which the magnetic material layer is to be painted is previously treated with corona and then the magnetic material layer is painted on the face.

6. The substrate structure as claimed in claim 3, wherein the face of the substrate on which the magnetic material layer is to be painted is previously treated with corona and then the magnetic material layer is painted on the face.

7. The substrate structure as claimed in claim 1, wherein the face of the substrate on which the magnetic material layer is to be painted is previously treated with flame and then the magnetic material layer is painted on the face.

8. The substrate structure as claimed in claim 2, wherein the face of the substrate on which the magnetic material layer is to be painted is previously treated with flame and then the magnetic material layer is painted on the face.

9. The substrate structure as claimed in claim 3, wherein the face of the substrate on which the magnetic material layer is to be painted is previously treated with flame and then the magnetic material layer is painted on the face.

10. The substrate structure as claimed in claim 1, wherein the face of the substrate on which the magnetic material layer is to be painted is previously ground and then the magnetic material layer is painted on the face.

11. The substrate structure as claimed in claim 2, wherein the face of the substrate on which the magnetic material layer is to be painted is previously ground and then the magnetic material layer is painted on the face.

12. The substrate structure as claimed in claim 3, wherein the face of the substrate on which the magnetic material layer is to be painted is previously ground and then the magnetic material layer is painted on the face.

13. The substrate structure as claimed in claim 1, wherein the face of the substrate on which the magnetic material layer is to be painted is previously painted with a surface property changing agent or a surface optical manufacturing agent and then the magnetic material layer is painted on the face.

14. The substrate structure as claimed in claim 2, wherein the face of the substrate on which the magnetic material layer is to be painted is previously painted with a surface property changing agent or a surface optical manufacturing agent and then the magnetic material layer is painted on the face.

15. The substrate structure as claimed in claim 3, wherein the face of the substrate on which the magnetic material layer is to be painted is previously painted with a surface property changing agent or a surface optical manufacturing agent and then the magnetic material layer is painted on the face.

16. The substrate structure as claimed in claim 1, wherein the face of the substrate on which the magnetic material layer is to be painted is previously painted with an adhesive and then the magnetic material layer is painted on the face.

17. The substrate structure as claimed in claim 2, wherein the face of the substrate on which the magnetic material layer is to be painted is previously painted with an adhesive and then the magnetic material layer is painted on the face.

18. The substrate structure as claimed in claim 3, wherein the face of the substrate on which the magnetic material layer is to be painted is previously painted with an adhesive and then the magnetic material layer is painted on the face.

19. The substrate structure as claimed in claim 1, wherein a film made of interface material is previously laid or attached between the face of the substrate on which the magnetic material layer is to be painted and the magnetic material layer.

20. The substrate structure as claimed in claim 2, wherein a film made of interface material is previously laid or attached between the face of the substrate on which the magnetic material layer is to be painted and the magnetic material layer.

21. The substrate structure as claimed in claim 3, wherein a film made of interface material is previously laid or attached between the face of the substrate on which the magnetic material layer is to be painted and the magnetic material layer.

22. A substrate structure connectable by means of magnetic attraction, comprising a substrate and a magnetically attractable material layer painted on at least a part of at least one face of the substrate, whereby by means of the magnetically attractable material layer, the substrate can be magnetically attached to a corresponding face of an article with magnetic attraction.

23. The substrate structure as claimed in claim 22, wherein the magnetically attractable material layer is painted on one face of the substrate along a periphery thereof.

24. The substrate structure as claimed in claim 22, wherein the magnetically attractable material layer is entirely painted over at least one face of the substrate.

25. The substrate structure as claimed in claim 22, wherein the face of the substrate on which the magnetically attractable material layer is to be painted is previously treated with corona and then the magnetically attractable material layer is painted on the face.

26. The substrate structure as claimed in claim 23, wherein the face of the substrate on which the magnetically attractable material layer is to be painted is previously treated with corona and then the magnetically attractable material layer is painted on the face.

27. The substrate structure as claimed in claim 24, wherein the face of the substrate on which the magnetically attractable material layer is to be painted is previously treated with corona and then the magnetically attractable material layer is painted on the face.

28. The substrate structure as claimed in claim 22, wherein the face of the substrate on which the magnetically attractable material layer is to be painted is previously treated with flame and then the magnetically attractable material layer is painted on the face.

29. The substrate structure as claimed in claim 23, wherein the face of the substrate on which the magnetically attractable material layer is to be painted is previously treated with flame and then the magnetically attractable material layer is painted on the face.

30. The substrate structure as claimed in claim 24, wherein the face of the substrate on which the magnetically attractable material layer is to be painted is previously treated with flame and then the magnetically attractable material layer is painted on the face.

31. The substrate structure as claimed in claim 22, wherein the face of the substrate on which the magnetically attractable material layer is to be painted is previously ground and then the magnetically attractable material layer is painted on the face.

32. The substrate structure as claimed in claim 23, wherein the face of the substrate on which the magnetically attractable material layer is to be painted is previously ground and then the magnetically attractable material layer is painted on the face.

33. The substrate structure as claimed in claim 24, wherein the face of the substrate on which the magnetically attractable material layer is to be painted is previously ground and then the magnetically attractable material layer is painted on the face.

34. The substrate structure as claimed in claim 22, wherein the face of the substrate on which the magnetically attractable material layer is to be painted is previously painted with a surface property changing agent or a surface optical manufacturing agent and then the magnetically attractable material layer is painted on the face.

35. The substrate structure as claimed in claim 23, wherein the face of the substrate on which the magnetically attractable material layer is to be painted is previously painted with a surface property changing agent or a surface optical manufacturing agent and then the magnetically attractable material layer is painted on the face.

36. The substrate structure as claimed in claim 24, wherein the face of the substrate on which the magnetically attractable material layer is to be painted is previously painted with a surface property changing agent or a surface optical manufacturing agent and then the magnetically attractable material layer is painted on the face.

37. The substrate structure as claimed in claim 22, wherein the face of the substrate on which the magnetically attractable material layer is to be painted is previously painted with an adhesive and then the magnetically attractable material layer is painted on the face.

38. The substrate structure as claimed in claim 23, wherein the face of the substrate on which the magnetically attractable material layer is to be painted is previously painted with an adhesive and then the magnetically attractable material layer is painted on the face.

39. The substrate structure as claimed in claim 24, wherein the face of the substrate on which the magnetically attractable material layer is to be painted is previously painted with an adhesive and then the magnetically attractable material layer is painted on the face.

40. The substrate structure as claimed in claim 22, wherein a film made of interface material is previously laid or attached between the face of the substrate on which the magnetically attractable material layer is to be painted and the magnetically attractable material layer.

41. The substrate structure as claimed in claim 23, wherein a film made of interface material is previously laid or attached between the face of the substrate on which the magnetically attractable material layer is to be painted and the magnetically attractable material layer.

42. The substrate structure as claimed in claim 24, wherein a film made of interface material is previously laid or attached between the face of the substrate on which the magnetically attractable material layer is to be painted and the magnetically attractable material layer.
